(19) United States
(12) Patent Application Publication
(10) Pub. No.: US 2014/0238296 A1
(43) Pub. Date: Aug. 28, 2014

(54) Automated Paint Application System

(71) Applicant: John F. Grimes, Saskatchewan (CA)

(72) Inventor: John F. Grimes, Saskatchewan (CA)

(21) Appl. No.: 13/776,120

(22) Filed: Feb. 25, 2013

(51) Int. Cl. B05C 11/00

(52) U.S. Cl. CPC B05C 11/00
USPC 118/696

(57) ABSTRACT

An automated paint application system for automatically, safely and efficiently painting an image onto a structure. The automated paint application system generally includes an first track and a second track which are secured to a structure in parallel relationship with each other. An applicator mount is secured between the upper and second tracks. Sprockets are utilized on the tracks to allow the applicator mount to horizontally traverse the tracks. A paint applicator movably secured to the applicator mount through use of an applicator sprocket such that the paint applicator may vertically traverse the applicator mount. A controller may be provided to wirelessly direct the present invention to position itself and dispense paint in a manner which automatically paints an image on the structure.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a paint applicator and more specifically it relates to an automated paint application system for automatically, safely and efficiently painting an image onto a structure.

2. Description of the Related Art

Any discussion of the related art throughout the specification should in no way be considered as an admission that such related art is widely known or forms part of common general knowledge in the field.

Large structures such as water towers, grain storage buildings and the like often have large images painted on them. For example, water towers often have the name of a town or city painted thereon, sometimes with an additional image. Large buildings will often have advertisements or signs painted on their sides.

When painting images on such large structures, it is often required that a painter go up on a scaffolding or other device and manually paint the image. While this methodology has worked in the past, it has often lead to injuries or even death due to the hazards related with being suspended next to a large structure at a significant height above the ground.

Because of the inherent problems with the related art, there is a need for a new and improved automated paint application system for automatically, safely and efficiently painting an image onto a structure.

### BRIEF SUMMARY OF THE INVENTION

The invention generally relates to a paint applicator which includes an first track and a second track which are secured to a structure in parallel relationship with each other. An applicator mount is secured between the first and second tracks. Sprockets are utilized on the tracks to allow the applicator mount to horizontally traverse the tracks. A paint applicator movably secured to the applicator mount through use of an applicator sprocket such that the paint applicator may vertically traverse the applicator mount. A controller may be provided to wirelessly direct the present invention to position itself and dispense paint in a manner which automatically paints an image on the structure.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a first upper perspective view of the present invention in use.

FIG. 2 is a second upper perspective view of the present invention in use.

FIG. 3 is a top view of the paint applicator of the present invention.

FIG. 4 is a top view illustrating positioning of paint applicators of the present invention with respect to a structure.

FIG. 5 is a top view of a paint applicator of the present invention in use.

### DETAILED DESCRIPTION OF THE INVENTION

### A. Overview.

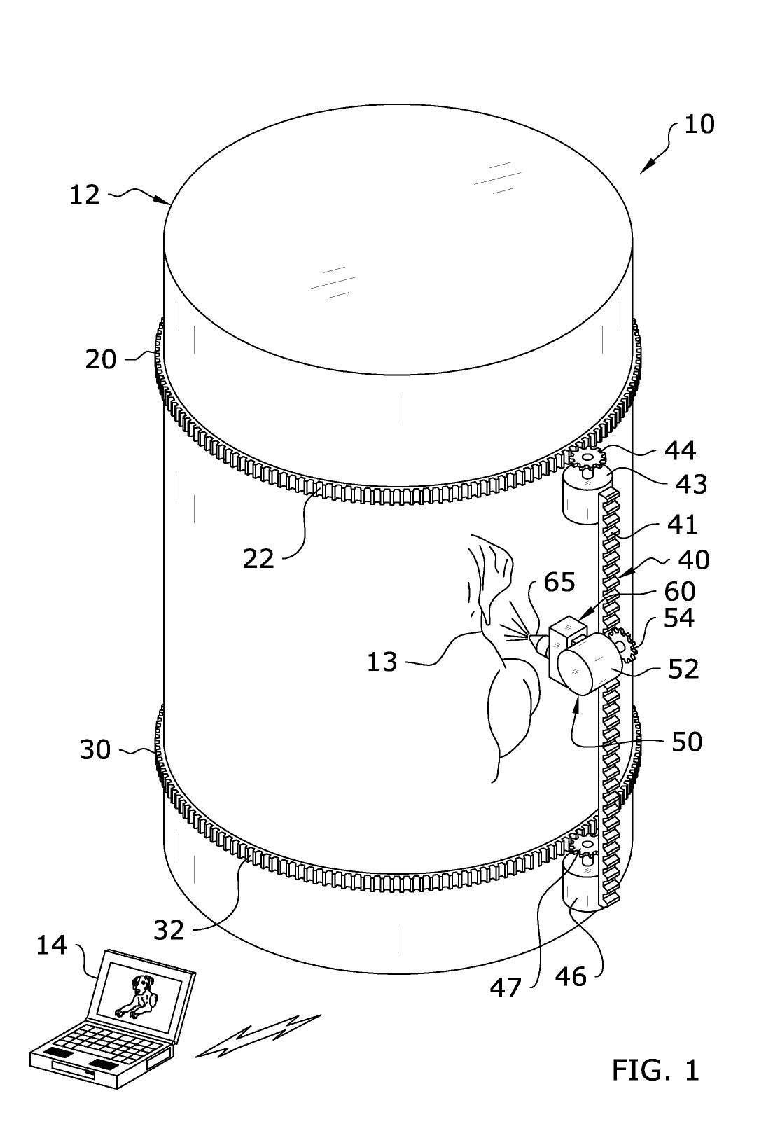

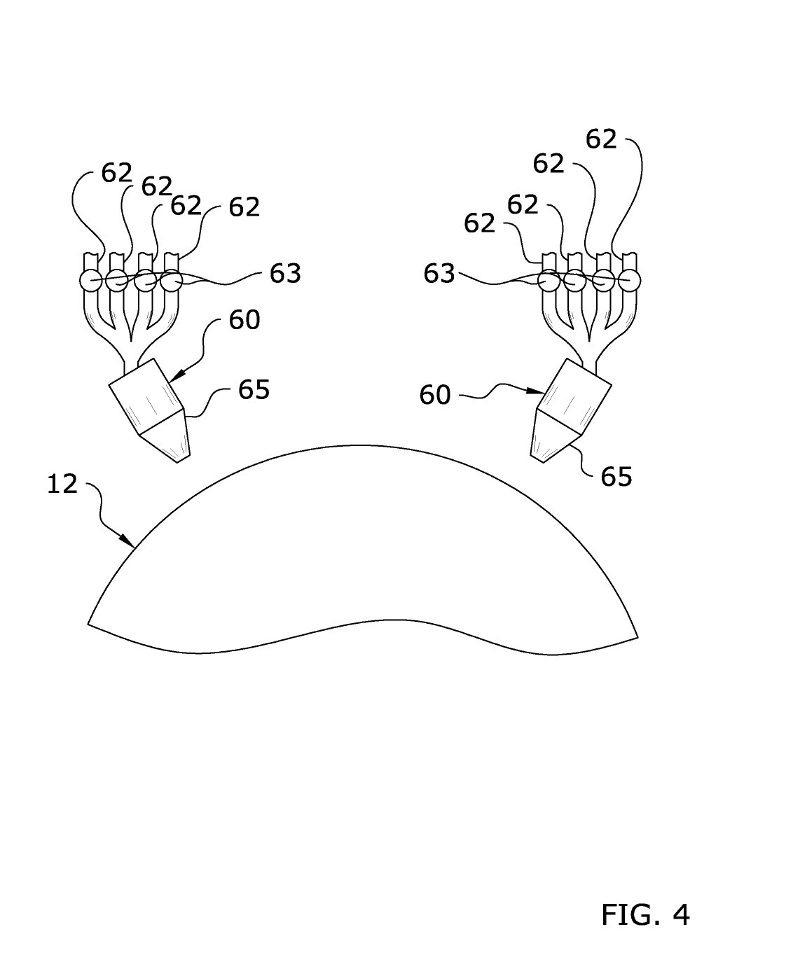

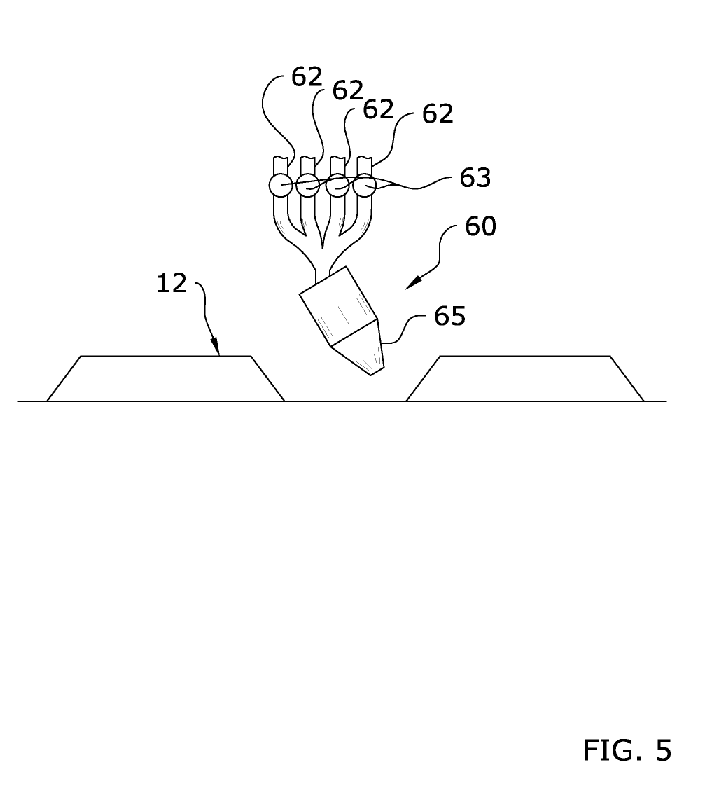

Turning now descriptively to the drawings, in which similar reference characters denote similar elements throughout the several views, FIGS. 1 through 5 illustrate an automated paint application system 10, which comprises an first track 20 and a second track 30 which are secured to a structure in parallel relationship with each other. An applicator mount 40 is vertically secured between the first and second tracks 20, 30. Sprockets 44, 47 are utilized on the tracks 20, 30 to allow the applicator mount 40 to horizontally traverse the tracks 20, 30. A paint applicator 60 movably secured to the applicator mount 40 through use of an applicator sprocket 54 such that the paint applicator 60 may vertically traverse the applicator mount 40. A controller 14 may be provided to wirelessly direct the present invention to position itself and dispense paint in a manner which automatically paints an image 13 on the structure 12.

### B. First and Second Tracks.

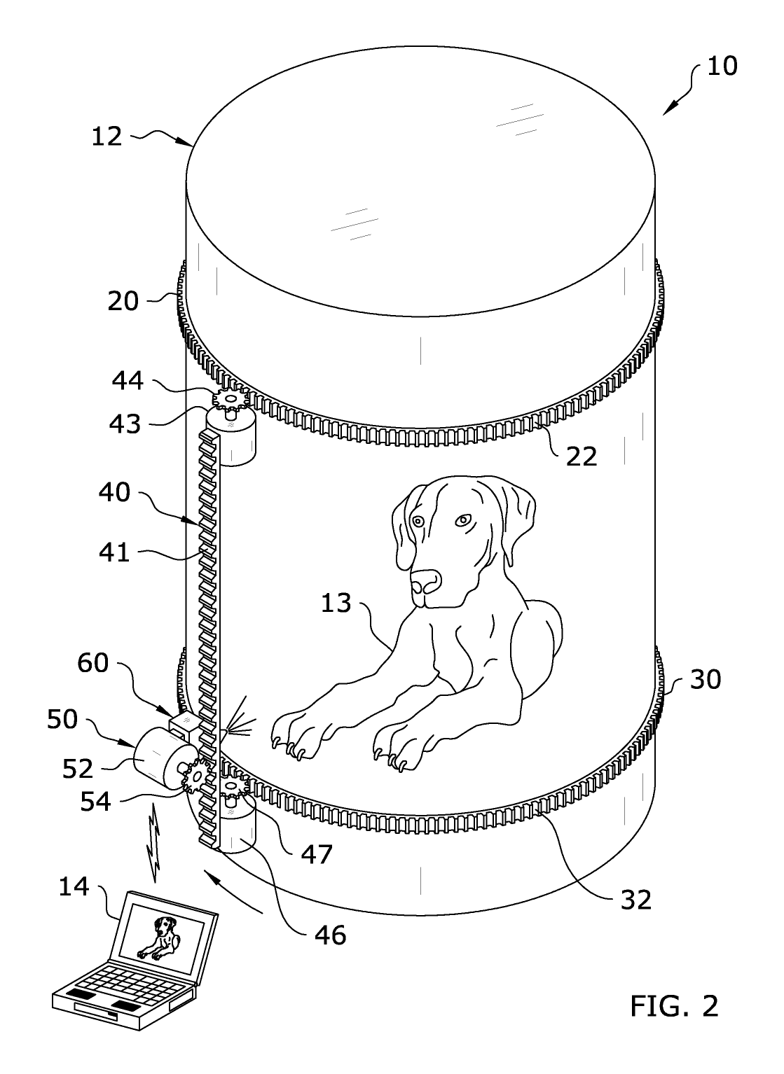

As shown in FIGS. 1 and 2, the present invention utilizes a pair of tracks 20, 30 to support the applicator mount 40 and allow it to traverse over the structure 12 to be painted. Preferably, where the structure 12 being painted is upright, a first track 20 and a second track 30 will be utilized, wherein the first and second tracks 20, 30 are spaced-apart from each other and run parallel with respect to the other.

The first track 20 will generally be positioned at an upper end of the area of the structure 12 which is to be painted. The first track 20 may be secured to the structure 12 with various methods known in the arts, such as through usage of temporary fasteners or scaffolding structures. The second track 30 will generally be positioned at a lower end of the area of the structure 12 to be painted and similarly may be secured to the structure 12 with various methods known in the art. Preferably, both of the tracks 20, 30 will be removably secured to the structure so that they may be easily removed and transferred to storage or for use on a different structure.

It is appreciated that, in different embodiments for different applications, the first and second tracks 20, 30 may be positioned at various locations and in various orientations. While the figures illustrate exemplary embodiments utilizing an upper first track 20 and a lower second track 30, it is appreciated that the tracks 20, 30 may be positioned horizontally, diagonally or in any orientation so long as the applicator mount 40 may be positioned and moved therebetween for application of paints. In other embodiments, only a single track 20 may be utilized.

Various types of tracks 20, 30 may be utilized with the present invention and the exemplary configuration shown in the figures should not be construed as limiting the scope of the present invention. In a preferred embodiment shown in the figures, the first track 20 will include a plurality of treads 22 running along its length. Similarly, the second track 30 will includes its own plurality of treads 32 running along its length. The treads 22, 32 are utilized to allow the sprockets 44, 47 of the applicator mount 40 to traverse the tracks 20, 30 when the present invention is in use.

### C. Applicator Mount.

The present invention includes an applicator mount 40 which is movably secured to both the first and second tracks 20, 30 as shown in FIGS. 1 and 2. The applicator mount 40 is generally comprised of a vertically-oriented track linked at its upper end to the first track 20 and at its lower end to the second track 30. The applicator mount 40 preferably includes its own treads 41 which are utilized to allow the applicator assembly 50 to traverse the applicator mount 40 and thus adjust vertically for painting.

The applicator mount 40 includes an upper motor 43 fixedly secured to its upper end as shown in the figures. The upper motor 43 may be comprised of various types of motors, such as electric or gas. An upper sprocket 44 is drivably secured to the upper motor 43 such that the motor 43 acts to rotate the upper sprocket 44. The upper sprocket 44 is secured to the first track 20 to aid with horizontally moving the applicator mount 40 across the structure 12.

The applicator mount 40 similarly includes a lower motor 46 fixedly secured to its lower end as shown in the figures. The lower motor 46 may be comprised of various types of motors, such as electric or gas. A lower sprocket 47 is drivably secured to the lower motor 46 such that the motor 46 acts to rotate the lower sprocket 47. The lower sprocket 47 is secured to the second track 30 to aid with horizontally moving the applicator mount 40 across the structure 12.

It is appreciated that the movement of the applicator mount 40 with respect to the tracks 20, 30 may be effectuated through various methods, such as by being belt-driven, rack and pinion driven, lead screw driven, hydraulically drive and the like.

### D. Applicator Assembly.

The present invention utilizes an applicator assembly 50 which traverses the applicator mount 40 vertically to apply paint to the structure 12 to create the image 13. The applicator assembly 50 is comprised of an applicator motor 52 and sprocket 54 which intermesh with the treads 41 of the applicator mount 40 to allow the applicator assembly 50 to traverse vertically.

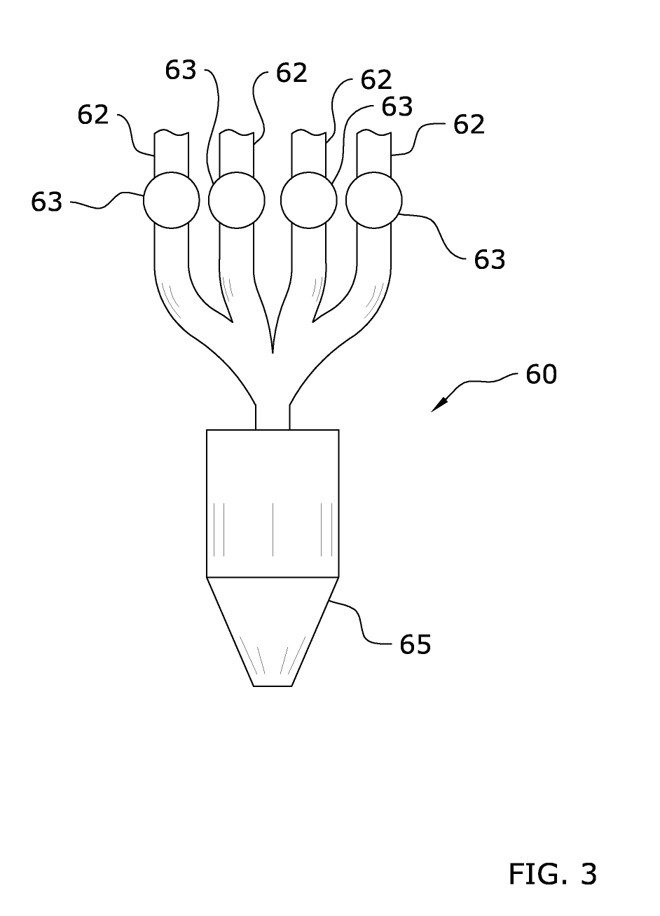

The applicator assembly 50 includes an attached paint applicator 60 which applies the paint to the structure 12 as described herein. The paint applicator 60, which is shown in detail in FIG. 3, generally includes a plurality of paint conduits 62 which converge into a single conduit prior to terminating into an applicator nozzle 65. Each of the paint conduits 62 includes a valve 63 to selectively allow paint to pass through when needed.

Preferably, each of the paint conduits 62 will be adapted to transfer a single color of paint. Thus, by selectively opening and/or closing the valves 63, different paint colors or combinations of colors may be applied to the structure 12 through the applicator nozzle 65. The control of the valves 63 will generally be controlled by a controller 14 adapted to control the various functionality of the present invention as described below.

The paint applicator 60 may vary in form for different embodiments of the present invention. Multiple variations of the paint applicator 60 may be utilized to vary the type of spray pattern being applied. For example, different pain applicators 60 may be utilized for large, round painted patterns than would be used with narrow, small patterns such as for trim. The paint applicator 60 may also be computer-controlled to spray anything from large round or flat patterns to small, fine patterns.

### E. Operation of Preferred Embodiment.

In use, the upper and second tracks 20, 30 are first secured to the structure 12 as shown in FIG. 1. The applicator mount 40 may then be secured between the upper and second tracks 20, 30, with the upper sprocket 44 movably secured to the treads 22 of the first track 20 and the lower sprocket 47 movably secured to the treads 32 of the second track 30. Thus, the applicator mount 40 will be adapted to horizontally traverse the upper and second tracks 20, 30.

The applicator assembly 50 may then be secured to the applicator mount 40, with the applicator sprocket 54 movably secured to the treads 41 of the applicator mount 40 such that the applicator assembly 50 may vertically traverse the applicator mount 40.

The overall operation of the present invention will be directed by a controller 14, such as a laptop, personal computer or tablet. The controller 14 may be connected to the present invention via wires or a wireless connection as shown in the figures. The controller 14 will receive the image 13 to be painted on the structure 12 and then automatically direct movement of the applicator mount 40 and applicator assembly 50 to proper positioning for painting. The controller 14 will also control the valves 63 of the paint applicator 60 to properly dispense the paint colors needed to complete the image 13.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An automated paint application system, comprising:
a first track secured to a structure;
a second track secured to said structure;
an applicator mount secured between said first track and said second track, said applicator mount being adapted to traverse across said structure; and
a paint applicator secured to said applicator mount, said paint applicator being adapted to vertically traverse across said structure.

2. The automated paint application system of claim 1, wherein said first track includes a plurality of treads.

3. The automated paint application system of claim 2, wherein said second track includes a plurality of treads.

4. The automated paint application system of claim 3, wherein a first end of said applicator mount includes a motor and an upper sprocket for traversing said first track.

5. The automated paint application system of claim 4, wherein a second end of said applicator mount includes a motor and a lower sprocket for traversing said second track.

6. The automated paint application system of claim 1, wherein said first track is parallel with respect to said second track.

7. The automated paint application system of claim 1, wherein said paint applicator includes an applicator motor and an applicator sprocket for traversing said applicator mount.

8. The automated paint application system of claim 1, wherein said paint applicator includes a plurality of paint conduits, each of said paint conduits being adapted to transfer a different colored paint.

9. The automated paint application system of claim 8, wherein each of said paint conduits includes a valve.

10. The automated paint application system of claim 9, further comprising a controller wirelessly connected to said paint applicator.

11. The automated paint application system of claim 1, said first track being removably secured to an upper end of said structure.

12. The automated paint application system of claim 11, said second track being removably secured to a lower end of said structure.

13. An automated paint application system, comprising:
an upper track removably secured to an upper end of said structure;
a lower track removably secured to a lower end of said structure, said upper and lower tracks running parallel with respect to each other;
an applicator mount secured between said first track and said second track, said applicator mount being adapted to traverse across said structure; and
a paint applicator secured to said applicator mount, said paint applicator being adapted to vertically traverse across said structure.

14. The automated paint application system of claim 13, wherein said upper track includes a plurality of treads.

15. The automated paint application system of claim 14, wherein said lower track includes a plurality of treads.

16. The automated paint application system of claim 15, wherein a first end of said applicator mount includes a motor and an upper sprocket for traversing said upper track and wherein a second end of said applicator mount includes a motor and a lower sprocket for traversing said lower track.

17. The automated paint application system of claim 13, wherein said paint applicator includes an applicator motor and an applicator sprocket for traversing said applicator mount.

18. The automated paint application system of claim 17, wherein said paint applicator includes a plurality of paint conduits, each of said paint conduits being adapted to transfer a different colored paint.

19. The automated paint application system of claim 18, wherein each of said paint conduits includes a valve.

20. An automated paint application system, comprising:
an upper track removably secured to an upper end of said structure, wherein said first track includes a plurality of treads;
a lower track removably secured to a lower end of said structure, said upper and lower tracks running parallel with respect to each other, wherein said lower track includes a plurality of treads;
an applicator mount secured between said first track and said second track, said applicator mount being adapted to traverse across said structure, wherein a first end of said applicator mount includes a motor and an upper sprocket for traversing said upper track and wherein a second end of said applicator mount includes a motor and a lower sprocket for traversing said lower track; and
a paint applicator secured to said applicator mount, said paint applicator being adapted to vertically traverse across said structure, wherein said paint applicator includes an applicator motor and an applicator sprocket for traversing said applicator mount, wherein said paint applicator includes a plurality of paint conduits, each of said paint conduits being adapted to transfer a different colored paint, wherein each of said paint conduits includes a valve.
